(19) United States
(12) Patent Application Publication
(10) Pub. No.: US 2011/0320399 A1
(43) Pub. Date: Dec. 29, 2011

(54) ETL BUILDER

(75) Inventors: Mark Joseph Ledwich, Queensland (AU); James Henry, Queensland (AU); Frank Chi-Jao Lin, Queensland (AU)

(73) Assignee: ZAP HOLDINGS LIMITED, Ternerife (AU)

(21) Appl. No.: 13/148,782

(22) PCT Filed: Feb. 9, 2010
(86) PCT No.: PCT/AU2010/000135

§ 371 Date: Sep. 19, 2011

(30) Foreign Application Priority Data
Feb. 10, 2009 (AU) 2009900510

(51) Int. Cl. G06F 17/30

(52) U.S. Cl. 707/602; 707/E17.005

(57) ABSTRACT

A method of building a staging database which examines the staging database metadata and constructs a schedule of operations to extract the data, transform it and load it into the staging database by using normalisation, translation blocks and filtering to create a business view of the data that can be seen using standard query languages. This is applied to products such as Navision in building an OLAP cube for use in business intelligence applications.

### BACKGROUND TO THE INVENTION

Relational databases for CRM and ERP are usually customised to suit the business needs of particular industries. Although some computer companies provide cubes that can be used with these databases they do not take account of the customisations that have taken place. To enable BI systems to carry out their analysis a cumbersome and expert driven process of synchronizing the databases to the analysis cube is needed. The cost of this process is a deterrent to purchasing and implementing BI systems and only large enterprises can justify the costs involved.

In preparing an ERP system for BI the usual steps are to establish the business requirements, source the data requirements, design, build, implement and also manage security.

The first step of this process elicits the business requirements for the system from the users in the organization. This would typically involve a consultant interviewing users around business processes and jointly determining the information those users require to do their job on a day to day basis as well as provide them with information to improve their decision making capabilities. Once business requirements have been gathered, the consultant will identify what data is required and in which system that this data currently resides.

The design phase will be undertaken by the technical consultant and will consist of the following items.

Extraction Transformation and Load (ETL)
The data is extracted from each source system into a staging database. This database is transformed into a star schema structure. Each ETL task must be designed to do this task efficiently. Transformation of the data also need to be designed at this point such as converting methods of converting complex ERP structures into simple reporting structures.

Data Warehouse Design
The warehouse must be designed in such a way as to allow large volumes of data to be accessed rapidly. It must also have a structure that will allow reports to be easily constructed against them.

Cube Design
The cube must be designed so that it can support all of the business requirements. This is typically a complex iterative process involving business analysts and business intelligence specialists. Cubes are constructed of measures and dimensions. Measures represent how an item is measured. For example, a sales representative is measured against revenue and margin. Dimensions break the measures down into business categories. For example, a sales representative is a dimension, the customer is a dimension and the date is a dimension.

Report Design
Reports must be designed to meet the business requirements. Report Parameters, subtotals, headings and format need to be thought through.

Once the design phase is completed, the build phase commences and the following items must be created. As this is technical in nature, a business intelligence developer usually performs this task. For example, with Microsoft's SQL Server, the following tasks would need to be performed by a product specialist:

| Task | Expertise Required |
|---|---|
| Create ETL Jobs | SQL Server Integration Services |
| Build data warehouse | SQL Server Relational Databases |
| | SQL Server Management Studio |
| Build Cubes | SQL Server Analysis Services |
| Report Design | SQL Server Reporting Services |

The implementation phase includes the steps:

Installation
Install the ETL jobs, cubes, data warehouse and reports.

Testing
The whole process must be tested to ensure that the cube and the reports are delivering the correct results to the user. This is normally done by reviewing reports from source systems and then validating them against the BI system.

Training
Ensure that the users can use the cubes and the reports efficiently and that technical support staff have the ability to maintain and customize the system over time.

Traditionally, security requirements for the BI system were gathered as part of the requirements stage. This was built into the cube manually, but a major source of labour was ongoing maintenance and manual synchronization efforts to ensure only the right people saw privileged information.

As illustrated above, building a business intelligence solution for an ERP system is a labour-intensive, specialist-driven process with many complexities.

USA patent application 2005/0149583 discloses a method of merging data in two different versions of the same database by comparing the two databases' metadata and using a difference algorithm to identify the differences and then develop a metadata exchange strategy to merge the two databases.

WO 2007/95959 discloses a method of generating data warehouses and OLAP cubes without requiring knowledge of database query languages. The system uses a star schema. This approach still requires expertise in building the data ware house for the OLAP cube and this is often too expensive for smaller scale businesses.

WO 2007072501 discloses a system for a business performance platform that has a data source, an instrumentation layer for deriving measurement information from multiple formats and integrating it into a canonical format, a consolidation layer for filtering and preprocessing instrumentation layer output, a business modelling layer and a presentation layer.

USA application 2006/0271568 discloses a method of assembling a data ware house using data reduction, aggregate and dimension and fulfillment processes.

USA patent application 2005/0033726 discloses a business intelligence system that does a way with a data store and uses meta data view module to access data organised on the basis of data connection, data foundation, Business element and business view and security.

WO 2007072501 discloses a system for a business performance platform that has a data source, an instrumentation layer for deriving measurement information from multiple formats and integrating it into a canonical format, a consolidation layer for filtering and preprocessing instrumentation layer output, a business modelling layer and a presentation layer.

It is an object of this invention to provide an automatic method of preparing a data store and to then construct a schedule of operations to extract the data, transform it and load it into a staging database from which an OLAP Cube can be created.

### BRIEF DESCRIPTION OF THE INVENTION

To this end invention provides a method of building a staging database for use in creating an OLAP cube for business intelligence applications, which examines the staging metadata database and constructs a schedule of operations to extract the data, transform it and load it into the staging database by using normalisation, translation blocks and filtering to create a business view of the data that can be seen in the cube using standard query languages.

As illustrated above, building a business intelligence solution for an ERP system is a labour-intensive, specialist-driven process with many complexities. The present invention presents a method for automating the complex ETL processes typically required in building a BI solution based on an ERP system. Of particular note, the invention does not require a traditional data warehouse to build a cube.

The final output of this invention is a staging database which is used as the source database in the process previously described in copending application 2008905207. The staging metadata database used in this invention is prepared according to the method of co-pending application . . . .

### DEFINITIONS

### CRM

Customer Relationship Management

### Cube

A multi-dimensional database optimized for fast retrieval and aggregation of data ETL—Extract Transform and load in data ware housing involves extracting data from outside sources, transforming the data to fit needs in the OLAP cube and loading it into a staging data base

DSV Data Source View—a view of the base system data which maps more naturally to its definition in the cube than the raw data

### Database Schema

The schema of a database system is its structure described in a formal language supported by the database management system (DBMS). In a relational database, the schema defines the tables, the fields in each table, and the relationships between fields and tables.

### ERP

Enterprise Resource Planning is an industry term for the broad set of activities supported by multi-module application software that helps a manufacturer or other business manage the important parts of its business, including product planning, parts purchasing, maintaining inventories

### MDX

The leading query language for multi-dimensional databases is MDX, which was created to query OLAP databases, and has become widely adopted with the realm of OLAP applications.

### Normalization

In the field of relational database design, normalization is a systematic way of ensuring that a database structure is suitable for general-purpose querying and free of certain undesirable characteristics—insertion, update, and deletion anomalies—that could lead to a loss of data integrity. However, this form is not optimal for querying which is why OLAP cubes have a different structure.

### OLAP

OnLine Analytical Processing systems enable executives to gain insight into data by providing fast, interactive access to a variety of possible views of information.

The following definitions introduce concepts that reflect the multidimensional view and are basic to OLAP.

A “dimension” is a structure that categorizes data. Commonly used dimensions include customer, product, and time. Typically, a dimension is associated with one or more hierarchies. Several distinct dimensions, combined with measures, enable end users to answer business questions. For example, a Time dimension that categorizes data by month helps to answer the question, “Did we sell more widgets in January or June?”

A “measure” includes data, usually numeric and on a ratio scale, that can be examined and analysed. Typically, one or more dimensions categorize a given measure, and it is described as “dimensioned by” them.

A “hierarchy” is a logical structure that uses ordered levels as a means of organizing dimension members in parent-child relationships. Typically, end users can expand or collapse the hierarchy by drilling down or up on its levels.

A “level” is a position in a hierarchy. For example, a time dimension might have a hierarchy that represents data at the day, month, quarter and year levels.

An “attribute” is a descriptive characteristic of the elements of a dimension that an end user can specify to select data. For example, end users might choose products using a colour attribute. In this instance, the colour attribute is being used as an “axis of aggregation”. Some attributes can represent keys or relationships into other tables.

A “query” is a specification for a particular set of data, which is referred to as the query's result set. The specification requires selecting, aggregating, calculating or otherwise manipulating data. If such manipulation is required, it is an intrinsic part of the query.

“Metadata” is a key concept involved in this invention. Metadata is essentially data about data. It is information describing the entities in a database (either relational or multidimensional). It also contains information on the relationship between these entities and the security information detailing what information users are permitted to see.

### Relationship

Data is typically stored in multiple tables in a database. Often the records in one table relate to an entity in another table. Where this is the case, the two tables are considered to be related. In a relational database for example, a special value can be stored with each row that links it to the base entity. For example, imagine a database with a customer table and an address table. The address table has an additional field, CustomerID, which links it with the corresponding customer record in the customer table.

### DETAILED DESCRIPTION OF THE INVENTION

A preferred embodiment of the invention will be described with reference to the drawings in which:

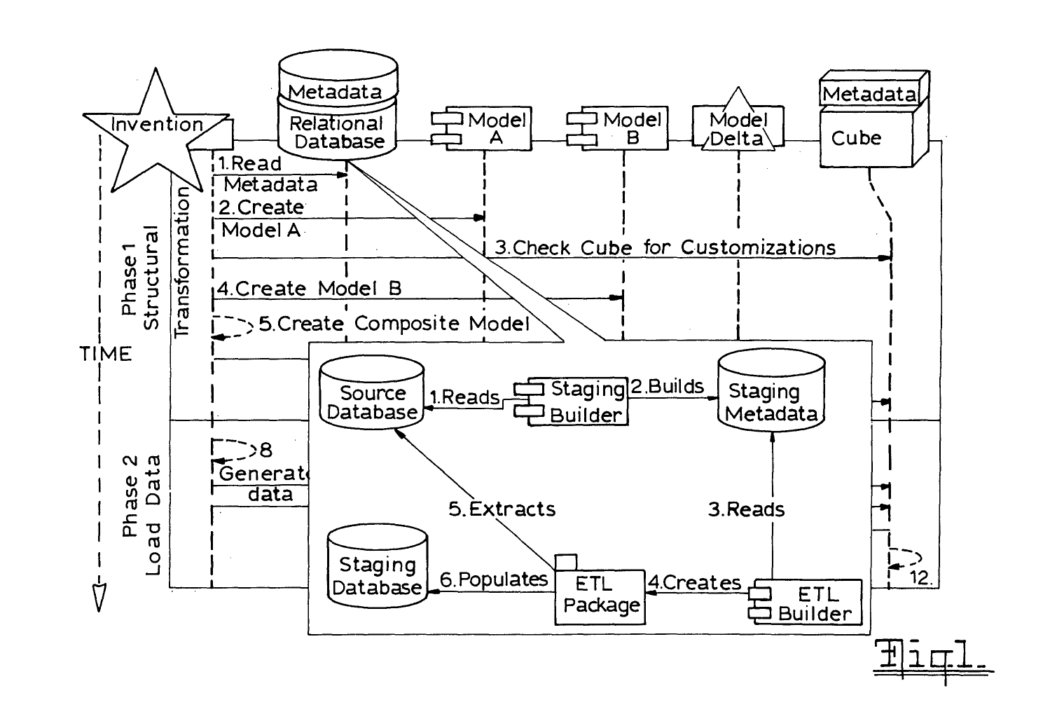

FIG. 1 is a schematic outline of the system which utilises the ETL builder of this invention.

This invention uses the staging metadata as prepared by copending application PCT/AU09/001,326 the disclosures of which are hereby incorporated by reference.

### ETL Builder

The ETL builder examines the staging database metadata and constructs a schedule of operations to extract the data, transform it and load it into the staging database. This schedule can then be translated into an appropriate language for the database management system, such as SQL Server Integration Services packages, and then handed off for execution.

### De-normalization

Most databases are in a relatively normalized form which facilitates smaller database sizes and faster updates but this is suboptimal for querying and analysis. They also lead to relatively complex cubes.

The present invention includes a de-normalization step which simplifies the resulting cube structure and improves performance. This process is outlined in copending application AU2009900509 Once this new table structure has been derived, the present invention automatically generates the ETL code necessary to effect this denormalization. A description of the derivation of this structural change is included here for reference.

This is achieved by combining two or more tables together, such that each row contains all the information, originally shared across tables, relevant to each record.

### EXAMPLE

Consider the following tables:

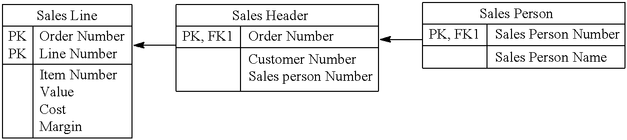

A user wishes to report on sales value, cost of sale and margin, and this is normally done by summarizing the items on the Sales Line table. In this case however, the user also wants to view the same values by Sales Person.

Ordinarily, to do this in the cube it would mean that we have to include the Sales Header table, which is really only needed for its Customer Number and Sales Person Number fields.

### Solution

There are 3 ways of handling this
1. Modify the query in the cube to include all three tables
2. Merge the fields of the three tables into a single table.
3. Add the items as dimensions and measure groups

Option 1 represents the status quo and leads to a complex cube with poor performance. Option 3 leads to an unnecessarily complex cube with referential dimensions.

The best solution is Option 2 and results in the following table which retains all information but allows for faster, simpler queries.

Sales

Order Number
Line Number
Item Number
Value
Cost
Margin
Customer Number
Sales Person Number

### Translation Block

Often the source data of a specific application will have its own nuances and way of doing things that make it difficult to unwind and group data in order for analysis. The present invention provides application blocks that allow you to process the source data of specific applications to facilitate comprehensive analysis and reporting. Generic operations supported are
Lookup tables
Recursively expanding ranges
Filtering
Parsing basic mathematical expressions and translating them into MDX

These basic capabilities can be configured to support specific applications, allowing the user to import these reporting designs directly into the solution, providing a seamless reporting environment that faithfully reflects their current system (for example, financial statement designs derived from account schedules in Microsoft Dynamics NAV).

### Financial Statement Designs for Microsoft Dynamics NAV (Navision)

Navision refers to financial statement designs as account schedules.

The Navision ERP system uses the Account Schedule Module to allow users to produce financial statements or key performance indicators. The user has the ability to create reports using Rows and columns which either contain ranges of account numbers from the general Ledger or expressions.

The example below refers to these two tables from a Navision system.

TABLE 1
Account Schedule

| Line No | Type | Line Description | Account |
|---|---|---|---|
| 10 | 1 | Cash and cash equivalents at | 11299 |
| | | beginning of period | |
| 20 | 1 | Movement in Clearing Accounts | 11399 |
| 30 | 1 | Movement in Deposits Held | 11599 |
| 40 | 1 | Movement in Earned & Unbilled | 11699 |
| | | Revenue | |
| 50 | 2 | Total | 10 + 20 + 30 + 40 |

TABLE 2
Chart of Accounts

| Account | Account Name | Totalling |
|---|---|---|
| 11299 | Cash & Cash Equivalents Total | 11100 . . . 11299 |
| 11399 | Clearing Accounts Total | 11300 . . . 11399 |
| 11599 | Deposits Held Total | 11500 . . . 11599 |
| 11699 | Earned & Unbilled Rev Total | 11600 . . . 11699 |

TABLE 3
Accounts Exploded
Stage Account Schedule

| Line | Account | Description | Group |
|---|---|---|---|
| 10 | 11100 | Cash & Cash Equivalents | Cash and cash equivalents at beginning of period |
| 10 | 11110 | Cash on Hand | Cash and cash equivalents at beginning of period |
| 10 | 11120 | Investments on Call | Cash and cash equivalents at beginning of period |
| 10 | 11122 | Listed Securities | Cash and cash equivalents at beginning of period |
| 10 | 11129 | Investments on Call Total | Cash and cash equivalents at beginning of period |
| 10 | 11130 | Operating Accounts | Cash and cash equivalents at beginning of period |
| 10 | 11152 | DBS Bank SGD | Cash and cash equivalents at beginning of period |
| 10 | 11153 | DBS Bank AUD | Cash and cash equivalents at beginning of period |
| 10 | 11169 | Operating Accounts Total | Cash and cash equivalents at beginning of period |
| 10 | 11170 | Petty cash floats | Cash and cash equivalents at beginning of period |
| 10 | 11172 | Petty Cash - Airlie Beach | Cash and cash equivalents at beginning of period |
| 10 | 11174 | Petty Cash - Sydney | Cash and cash equivalents at beginning of period |
| 10 | 11176 | Petty Cash - Korea | Cash and cash equivalents at beginning of period |
| 10 | 11179 | Petty cash Total | Cash and cash equivalents at beginning of period |
| 10 | 11190 | Voucher & Tokens | Cash and cash equivalents at beginning of period |
| 10 | 11192 | Corporate Gifts | Cash and cash equivalents at beginning of period |
| 10 | 11194 | Gift Vouchers | Cash and cash equivalents at beginning of period |
| 10 | 11196 | Parking Vouchers | Cash and cash equivalents at beginning of period |
| 10 | 11199 | Voucher & Tokens Total | Cash and cash equivalents at beginning of period |
| 10 | 11200 | Treasury Accounts | Cash and cash equivalents at beginning of period |
| 10 | 11299 | Cash & Cash Equivalents Total | Cash and cash equivalents at beginning of period |

### Step 1—Process Account Schedules

Account schedules are being imported into the solution to allow users to retain all of the IP built up by creating the schedules and have the advanced reporting capabilities which Zap offers.

The following is an example of a NAV account Schedule the major components as far as the Zap solution are concerned are schedule name, Line Number, Type, Description and Account number.

### Type

This example deals with two account types . . . .
1. Accounts—these contain accounts or account ranges, the accounts are used to Aggregate General Ledger totals. The ‘ . . . ’ is used to specify a range of accounts
2. Expressions—These contain expressions used on the report for calculated items in our example we are using + to add the lines together. The following may also be used when creating expressions:
   + Add
   − Subtract
   / Divide
   * Multiply
         | add
   . . . Range

The application must parse these expressions to allow them to be reported on using the cube. To do this the following steps need to be followed.

### Step 2—Lookup the General Ledger Accounts

Using the account number in the schedule the application will look up the relevant accounts on the Chart of Accounts table within NAV. In Table 2 the accounts have been returned after looking them up using the Accounts in the account schedule shown in Table 1.

In order to aggregate values from General Ledger Transaction (GL Trans) table we need to be using posting accounts. The accounts we have returned in table 1 are Total accounts which do not have any values posted against them in the general ledger. The Totalling field contains the range of posting accounts required to link to the transaction table. The Account 11299 ‘Cash & Cash Equivalents Total’ contains the range of 11100 to 11299, we will need to look up the accounts for this range to link to the GL Trans table.

### Step 3—Account Explosion

The records shown in Table 3 will now be inserted into the stage account schedule. If the exploded account number has a total account such as account 11169, it will also have to be exploded to ensure that only posting accounts are inserted.

### Step 4—Insert Dynamics NAV Dimensions

Each account schedule line may also have NAV Dimensions linked to them so another level of explosion has to take place for each Dimension added:

| Line | Totaling | Dimension1 Totaling |
|---|---|---|
| Revenue Area 10 . . . 30, Total | 6110 . . . 6195 | 10 . . . 30 |
| Revenue Area 40 . . . 85, Total | 6110 . . . 6195 | 40 . . . 85 |

| Line | Account | Dimension1 |
|---|---|---|
| Revenue Area 10 . . . 30, Total | 6110 | 10 |
| Revenue Area 10 . . . 30, Total | 6110 | 20 |
| Revenue Area 10 . . . 30, Total | 6110 | 30 |
| Revenue Area 40 . . . 85, Total | 6110 | 40 |
| Revenue Area 40 . . . 85, Total | 6110 | 50 |
| Revenue Area 10 . . . 30, Total | 6111 | 10 |
| Revenue Area 10 . . . 30, Total | 6111 | 20 |

The result of the explosion of all of these records now presents an issue when linking back to the GL transaction table as the granularity of the new account schedule line is lower than the account number. To resolve this a “many to many” dimension is created in the cube.

### Step 5—Inserting Expression Records

Once all the account schedule records and the accounts have been exploded the expressions can be inserted. The Nav expression must be now be parsed into MDX. In our example we are adding the lines together ‘10+20+30+40’.

This is achieved by looking up the relevant accounts and obtaining the maximum and minimum accounts numbers to create an MDX set. The line number 10 will be converted into the following

### [Account].[11100]:[Account].[11299]+[Account].[11300]:[Account].[113991]+[Account].[11500]:[Account].[11599]+[Account].[11600]:[Account].[11699]

This now forms a custom rollup in the Analysis Services cube.

### Many To Many Dimensions

In the particular embodiment of the invention used in this example, the “Many to Many” functionality of Microsoft Analysis Services is utilised to link the new converted account schedules back to the GL Entry table.

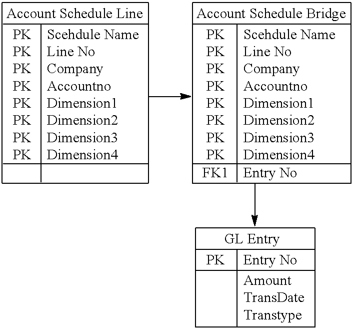

### Slowly Changing Dimensions

The “Slowly Changing Dimension” problem is a common one particular to reporting. Succinctly, this applies to cases where the attribute for a record varies over time. We give an example below:

Lisa is a customer with ABC Inc. She first lived in Brisbane, Queensland. So, the original entry in the customer lookup table has the following record:

| Customer Key | Name | State |
|---|---|---|
| 1000 | Lisa | Queensland |

At a later date, she moved to Sydney, New South Wales on January, 2009. How should ABC Inc. now modify its customer table to reflect this change? This is the “Slowly Changing Dimension” problem.

There are in general three ways to solve this type of problem, and they are categorized as follows:

Type 1: The new record replaces the original record. No trace of the old record exists.
Type 2: A new record is added into the customer dimension table. Therefore, the customer is treated essentially as two people.

| Customer Key | Name | State | Status |
|---|---|---|---|
| 1000 | Lisa | Queensland | Inactive |
| 1001 | Lisa | New South Wales | Active |

Type 3: The original record is modified to reflect the change.

The invention we present solves this problem automatically by applying the following policy:

Each record will by default employ a Type 1 approach, however if the user chooses to perform incremental updates to their cube then the Type 2 approach will be used.

### Business Views

To allow business users to quickly and easily create a view of their data for analysis, the present invention introduces the concept of a “Business View”. This invention empowers business users to filter data and introduce calculated fields to ETL jobs without any technical knowledge.

Often data will need to be excluded from a cube based on criteria defined by the user. Each filter will be applied at the table level. Users may also wish to include new columns that are calculated from others.

### Example

The TIVA Corporation has changed direction and has discontinued their ‘Bargain Bin’ product line. This data is of no use in reports or for cube analysis and needs to be excluded from the cube. To do this a filter must be applied to across the tables that reference product line.

The screen shot above illustrates how the invention allows the user to simply specify a filter condition. Behind the scenes, the invention translates this expression into an SQL statement in the SSIS package created by the tool.

The filter supports a full range of Boolean logical operations on any number of columns. Similarly, the calculated fields can be derived using any mathematical expression or set operation on the columns of the table.

### Global Filters and Calculated Expressions

Calculations and filters created using the same method as the business view can be applied to all tables where the columns contained in that expression are used. This eliminates the tedious and repetitive process of introducing common operations germane to many tables.

### Example 1

The ‘Bargain Bin’ product line may exist on various tables such as Sales Quotes or Inventory. The functionality will allow the user to automatically copy all of the filters to the other tables. If the field name is different data samples will be used to determine the correct column to apply the filter on.

### Example 2

Consider the case where the first 2 characters of the department code identify the cost centre for a department. A derived column can be created that identifies the cost centre and this would automatically be shared amongst all tables where the department code exists.

When large volumes of data of a transactional nature are included in the cube, past a particular threshold, the Wizard creates what is known as a relational dimension or ROLAP dimension, rather than a standard OLAP dimension. This results in smaller cubes, less processing time and greater query performance.

From the above it can be seen that the present invention provides a time and cost saving solution for automatically implementing the generated design of an OLAP cube by generating the necessary ETL code.

Those skilled in the art will realise that this invention may be implemented in embodiments other than those described without departing from the core teachings of this invention.

1. A computer operable method of building a staging database for use in creating an OLAP cube for business intelligence applications, which uses a computer to examine the staging database metadata and constructs a schedule of operations to extract the data, transform it and load it into the cube by using translation blocks that facilitate lookup tables, recursively expanding ranges, filtering and parsing of mathematical expressions into MDX.

2. A method as claimed in claim 1 for generating ETL packages that uses a computer to reproduce the business logic for report design stored in the source system.

3. A method as claimed in claim 2 which includes extracting data from a source system's reporting design system by expanding range hierarchies using expressions that have been stored within these designs and converting them into OLAP structures.

4. A method as in claim 1 where the user has the ability to add additional reporting functionality to the cube through creation of additional tables and business views.

5. A method as in claim 1 which transparently accounts for slowly changing dimensions by replacing a changed record and deleting the original or at the users instigation create a new record.

6. A method as in claim 4 where entities specified in the business view are automatically promulgated, by allowing the user to insert new expressions or filters.

7. A method as claimed in claim 2 in which the source databases are an ERP or CRM database.

8. A computer readable medium encoded with a data structure to examine the staging database metadata and constructs a schedule of operations to extract the data, transform it and load it into the cube by using translation blocks that facilitate lookup tables, recursively expanding ranges, filtering and parsing of mathematical expressions into MDX.
